(19) United States
(12) Patent Application Publication
(10) Pub. No.: US 2009/0179356 A1
(43) Pub. Date: Jul. 16, 2009

(54) Low Haze Thermoplastic Films, Methods and Manufacturing System For Forming the Same

(75) Inventors: Michael Friedman, Hawley, PA (US); Sergey Peshkovsky, Moscow (RU); Mzhelski Alexander, Moscow (RU); Hiroshi Shirai, Kawasaki-city (JP); Katsushi Watanabe, Kawasaki-city (JP)

Correspondence Address: BOND, SCHOENECK & KING, PLLC, ONE LINCOLN CENTER, SYRACUSE, NY, 13202-1355, US

(73) Assignees: AMA, INC., Hawley, PA (US); ASAHI KASEI CHEMICALS, Tokyo (JP)

(21) Appl. No.: 12/013,715

(22) Filed: Jan. 14, 2008

(51) Int. Cl. B29C 47/00; B29C 47/76; B29C 35/08; B06B 1/00

(52) U.S. Cl. 264/402; 264/176.1; 264/101; 264/442

(57) ABSTRACT

The present invention related generally to thermoplastic films, and, more particularly, to low haze thermoplastic films with high thickness uniformity, methods for manufacturing low haze thermoplastic films with high thickness uniformity, and manufacturing systems for forming the same.

### BACKGROUND OF THE INVENTION

1. Field of Invention

The present invention relates generally to thermoplastic films, and, more particularly, to low haze thermoplastic films with high thickness uniformity, methods for manufacturing low haze thermoplastic films with high thickness uniformity, and manufacturing systems for forming the same.

2. Description of Prior Art

Thermoplastic film is a polymer film made of thermoplastic polymer materials and formulations based on such materials. Thermoplastic polymer materials are polymers capable of being softened or molten into a liquid (melt) under heat and solidified when cooled. This cycle can be repeated many times (which is limited practically by the material's chemical stability; the material may degrade under the thermal and mechanical load).

Some of the most important applications of modern polymer film is in optical quality products such as solar panels, artistic glass laminates, interlayer for various safety glass structures, protection of electrical and biological cells and units, and the like. All of these applications need polymer films with very high thickness uniformity, superb optical properties, and, more particularly, very high transparency and very low haze.

Constant efforts are being made by many companies and researchers in the thermoplastic film industry to form thermoplastic films with improved optical properties, including very high transparency and very low haze. It is well known that for crystalline and semi-crystalline polymers, the haze is caused mainly by the polymer's morphology: the polymer crystals scatter the light within the film “body” creating the haze. Reduction of polymer crystallinity as well as reduction in the dimensions of crystals help to reduce the haze of film. This reduction of haze is usually achieved through two main methods: (1) incorporation of nucleation agents, and (2) sharp cooling of polymer melt after extrusion through dies. The incorporation of nucleation agents increases the number of crystals and makes them much smaller, and the sharp cooling of the film web reduces the overall crystallinity restricting the crystallization process. However, at a certain very small size of crystalline morphological units (“domains”) they become comparable in size to the wave length of visible light, and therefore the further reduction of the haze of film is theoretically impossible. Accordingly, the capabilities of the current haze reduction techniques are limited and not efficient for improvement of transparency and haze of film beyond certain values (optical thresholds), which may vary for different polymer materials.

The best polymer film made of crystalline and semi-crystalline polymers by current methods have haze values (measured by standard methods and devices) on a level of several percent, typically for film 1-10 mil thick in the range from 5% to 10%. Even the so-called polymer film—“champions” may only reach the level of haze of ˜4-5% at thickness 4-8 mil (100-200 microns). The exception is Polyvinylbutiral (PVB) film used as an interlayer in glass laminates for car windshields, which has a very low haze of 0.3%-1% at a thickness of several mil, but this polymer film is made of formulations based on PVB with high content of plasticizers (PVB is being plasticized for clarity and improvement of adhesion to glass surfaces, impact and tear resistance). In most other applications, however, the presence of plasticizers in the polymer formulations is undesirable due to the negative influence of plasticizers on mechanical, electrical, photovoltaic, barrier and other properties of film.

The physical nature of amorphous polymers, theoretically (and to some extent practically) not containing any crystalline phase, provides a relatively low haze and high transparency of extruded film. For example, haze of film made of Poly-methyl-methacrylate (PMMA), Polycarbonate (PC), Polystyrene (PS), Cyclic Polyolefins and other amorphous polymers may be as low as 2%-3%. Haze values of about 2% have been reported for film made by a few companies using newly developed amorphous thermoplastics (copolymers), highly polished casting drums as a part of the film take-off equipment after the extrusion die, and special cleaning of the initial polymer resin before film extrusion.

Several reasons for a haze level in amorphous polymers, and crystalline polymers with very low crystallinity and small crystals, remaining at a level of about 2% or higher include: (1) fluctuation of polymer density in the “body” of film occurring during extrusion and “frozen-in” after cooling of the extruded polymer web, (2) non-uniformity of film thickness in both transverse and machine directions, (3) relative roughness of the film surface (“surface imperfections”), and (4) as revealed by the instant application (as discussed further, infra), gases and volatiles in the form of microscopically distributed bubbles entrapped in the polymer material and remaining in the film in its solid state. The light scattering ability of the polymer films due to the above reasons still occurs even when the crystalline morphological units are very small, or absent completely.

The fluctuation of polymer density is due to the deficiency of mixing and homogeneity of polymer melt provided by current thermoplastic film manufacturing equipment.

In spite of the fact that the thickness uniformity of film can be controlled in the transverse direction (TD) through improvements of the design of extrusion dies, it is still on level of +/−7%-10% for the best extrusion processes. The thickness uniformity of film in the machine direction (MD) is much worse and reaches +/−15-25% for the best known current technology and equipment. This non-uniformity of film thickness is caused by pulsations of the melt output due to rotating screws of all known designs. Measures have been suggested to improve thickness uniformity in the machine direction (MD) such as implementation of receivers, static mixers, usage of longer screws, longer extrusion die lands and lips, etc. However, all suggested measures are costly and inefficient.

Gases in form of micro-bubbles are occurring due to gases and volatiles contained in pellets of polymer raw materials, air entrapped in the feeding section of the extruder and in the polymer melt, respectively, and as gas bi-products of polymer degradation under thermal and mechanical load of the material and instability in the film extrusion process.

Accordingly, there is a need for a thermoplastic film with haze levels below that previously described in the prior art, as well as a thermoplastic film with high thickness uniformity in both the transverse and machine directions (TD and MD) (where the thermoplastic film is substantially or completely free of plasticizers). There is also a need for a method and manufacturing system for forming the same that overcomes the aforementioned problems faced and not solved by the prior art.

### SUMMARY OF THE INVENTION

In accordance with an embodiment of the present invention, thermoplastic films, and, more particularly, low haze thermoplastic films with high thickness uniformity, methods for manufacturing low haze thermoplastic films with high thickness uniformity, and manufacturing systems for forming the same, are provided.

In accordance with an embodiment of the present invention, low haze thermoplastic films of an embodiment of the present invention, produced pursuant to the disclosed methods and manufacturing systems, comprise a haze value of 1.5% or lower, where the thermoplastic film is substantially or completely free of plasticizers.

In accordance with an embodiment of the present invention, low haze thermoplastic films of a preferred embodiment of the present invention, produced pursuant to the disclosed methods and manufacturing systems, comprise a haze value of 1.5% or lower at film thickness up to 8 mil (200 microns).

In accordance with an embodiment of the present invention, low haze thermoplastic films of a preferred embodiment of the present invention, produced pursuant to the disclosed methods and manufacturing systems, comprise a haze value of between 0.1% and 1.5%.

In accordance with an embodiment of the present invention, clear (high clarity, transparency), low haze thermoplastic films with improved optical properties made from crystalline, semi-crystalline, and amorphous polymer materials, and the like, where the thermoplastic films are substantially or completely free of plasticizers, are provided.

In accordance with an embodiment of the present invention, thermoplastic films with improved thickness uniformity in both the transverse and longitudinal (“machine”) directions, are provided. Correlation between the film haze and thickness non-uniformity in the machine direction has not been described in the literature prior to the instant disclosure.

In accordance with an embodiment of the present invention, thermoplastic films of a preferred embodiment of the present invention, produced pursuant to the disclosed methods and manufacturing systems, comprise a thermoplastic film with improved thickness uniformity in comparison to technology known in the art, in both the transverse direction (TD) of +/−4% or better, and machine direction (MD) of +/−3% or better.

In accordance with an embodiment of the present invention, thermoplastic films made from polyolefins and their copolymers of linear and cyclic chemical structures, as well as styrene copolymers and blends based on such copolymers with improved optical properties, are provided.

In accordance with an embodiment of the present invention, a manufacturing system for manufacturing the thermoplastic films of the embodiments of the present invention (and method of forming the same), as discussed supra, is provided. The manufacturing system of an embodiment of the present invention comprises a thermoplastic film extrusion line. The film extrusion line comprises a hopper and feeder unit for feeding polymer pellets into the film extrusion line, a two-stage cascade extruder system comprising a first extruder (“Extruder I”) and a second extruder (“Extruder II”) connected by a transition section, and an extrusion die with a plurality of sections. The polymer pellets are prepared and fed into the hopper and feeder unit, and then fed into Extruder I where the polymer pellets are compressed, melted, and mattered. The molten polymer material is then fed into the transition section (transition melt pipe). After passage through the transition section, the polymer material passes through Extruder II for creating a high pressure polymer melt and for mattering the melt into the extrusion die. The Extruder II is equipped with a port for connection to a vacuum system (which may alternatively be located in the transition section), including a vacuum pump with a pipe system for degassing the polymer melt before the mattering section of the screw of Extruder II. The extrusion die contains multiple individually adjustable (fine tuning) sections for heating and thickness adjustment of the melt. The melt is extruded from the multi-section die as a melt-web, which is fed through a take-off casting rolls unit for cooling and final shaping of the polymer film surface. The film extrusion line may also be equipped with a magneto-strictive ultrasonic generator for ultrasonic treatment (“ultrasonic honinging”) of the formed extruded film web after its partial cooling. The film web is then sent to a winding unit for making thermoplastic film rolls as a final product.

In accordance with an embodiment of the present invention, the manufacturing system of an embodiment of the present invention is operable to produce thermoplastic films with a haze level below 1.5% by combating the light scattering quality of the thermoplastic film due to: (1) fluctuation of polymer density in the “body” of film occurring during a normal extrusion process and “frozen-in” after cooling of the extruded polymer web; (2) non-uniformity of film thickness in both transverse (“TD”) and machine directions (“MD”); (3) relative roughness of the film surface (“surface imperfections”), and (4) gases and volatiles in the form of microscopically distributed bubbles entrapped in the polymer material and remaining in the film in its solid state.

The thermoplastic film extrusion line and process of an embodiment of the present invention reduces the fluctuation of polymer density through ultrasonic treatment (“ultrasonic honinging”) of the extruded film web, as described supra. Additionally, the ultrasonic honinging of the extruded film web allows for a smoother film surface, which in turn helps reduce light scattering and the haze of the thermoplastic film.

The TD thickness uniformity of the thermoplastic film of an embodiment of the present invention is positively influenced by the multi-section design of the die of an embodiment of the present invention. Specifically, the die has a sectioned design of the lips with a very large number of sections for heating and thickness adjustment. For example, the length of each of the sections could be no longer than 1/30 of the complete length of the die lips, practically no longer than one inch, which allows the die to have up to hundreds of die sections individually controlled in terms of the dimensions of their lip gaps and set up temperatures. Such a design allows for very fine individual tuning of each section providing a much better rheological adjustment and uniformity of the melt flow, and significant improvement of the TD thickness uniformity.

The MD thickness uniformity of the thermoplastic film of an embodiment of the present invention is achieved through the cascading of the two stage cascade extruder system (as opposed to one standard extruder with a longer screw in typical current film extrusion lines), which is separated by a transition melt pipe, as described supra. This design allows for the cutting-off of melt-flow pulsations that normally occur in the feeding and melting sections of standard extrusion machines, due to the inconsistency of feeding the polymer material through a standard extruder, as well as to screw rotation pulsations.

The vacuum system provided by the present invention for degassing the polymer melt assists in reducing and/or eliminating gases and volatiles in the form of micro-bubbles from the melt, which helps to reduce light scattering and the haze of the extruded thermoplastic film of the present invention. This aspect of an embodiment of the present invention, among others, is unique because the prior art does not teach or suggest degassing (devolatilization) of polymer melts as a method of improving optical properties and haze values of polymer film, as set forth herein.

### BRIEF DESCRIPTION OF THE DRAWINGS

The present invention will be more fully understood and appreciated by reading the following Detailed Description in conjunction with the accompanying drawings, in which:

FIG. 1a is a side perspective view illustrating a thermoplastic film extrusion line, according to an embodiment of the present invention.

FIG. 1b shows a top perspective view illustrating the thermoplastic film extrusion line, as shown in FIG. 1a, according to an embodiment of the present invention.

FIG. 2 shows a perspective view of an ultrasonic treatment (“honinging”) unit, according to an embodiment of the present invention.

FIG. 3 shows a measurement technique of measuring thickness uniformity and haze values of extruded thermoplastic polymer film, according to an embodiment of the present invention.

### DETAILED DESCRIPTION

Reference will now be made in detail to the present preferred embodiments of the invention, examples of which are illustrated in the accompanying drawings.

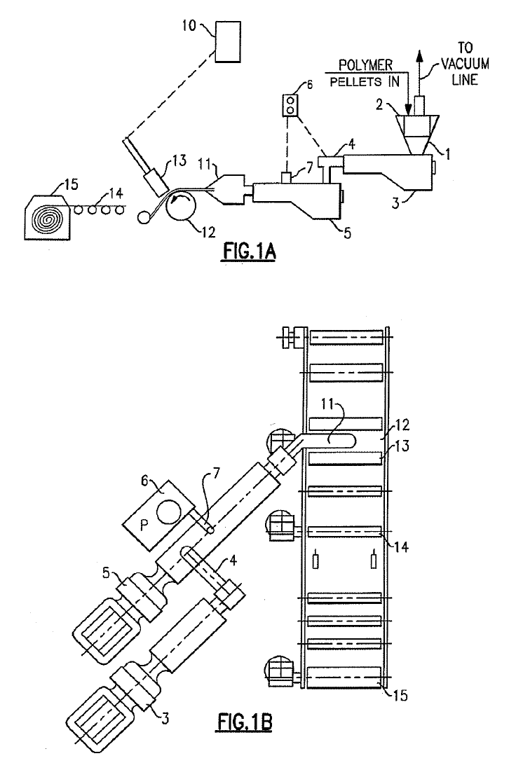

Referring to the drawings, wherein like reference numerals refer to like components, FIG. 1a shows a side perspective view illustrating a thermoplastic film extrusion line 100, according to an embodiment of the present invention. FIG. 1b shows a top perspective view illustrating the thermoplastic film extrusion line 100, as shown in FIG. 1a, according to an embodiment of the present invention. The thermoplastic film extrusion line 100 is described below with reference to the method of manufacturing thermoplastic film, according to an embodiment of the present invention.

As shown in FIG. 1a, polymer material in the form of standard pellets is fed into hopper 1 mounted above the first extruder 3. (It is preferable if the pellets are pre-dried and pre-heated if the polymer material is moisture sensitive or has absorbed excessive water during storage and transportation.). The hopper 1 may be equipped with an additional pre-heating unit, and vacuum chamber 2 for vacuuming out vapors, moisture and volatiles from the pellets and polymer melt in the first extruder 3. The polymer pellets are taken by the screw of the first extruder 3, and compressed and molten at the last section of the first extruder 3 (but could be compressed and molten in other sections of the first extruder 3). The compressed and molten polymer material is then transported to the transition unit with a capillary 4, which directs the melt into the second extruder 5. The material is homogenized in the second extruder 5 and pushed into a flat extrusion die 11 to be shaped in the form of a flat film/sheet web. A vacuum unit 6 is attached to an “evacuation” port located either in the transition unit 4 between the two extruders, or in the beginning of the mattering section 7 of the second extruder 5, and provides devolatilization of the polymer melt. The resulting film from the die 11 is cooled by a casting take-off roll (“casting drum”) 12, and then treated by the ultrasonic honinging unit (waveguide-radiator) 13 which produces ultrasonic vibrations (the “ultrasonic honinging” stage). At this “ultrasonic honinging” stage, the film web is treated in the regime of levitation to provide the film surface polishing without touching the metal surface of the vibrating unit, which is further described infra. One high frequency electrical generator 10 can be used to power the ultrasonic waveguide radiator for the film honinging unit 13 (as is shown on FIG. 1 as an example of engineering the concrete line). Finally, the fabricated and treated film is forwarded by the take-off rolls 14 to the winder 15.

Turning to FIG. 1b, a top perspective view of the first extruder 3 connected by the capillary or transition unit 4 to the second extruder 5, is shown. A top view of the vacuum unit 6, which is attached to the “evacuation” port 7, the casting take-off roll (“casting drum”) 12, the ultrasonic honinging unit 13, the take-off rolls 14 and the winder 15 are also shown.

In accordance with an embodiment of the present invention, as noted supra, the “cascade of the two extruders” (3,5) in one line sequence helps to cut the low frequency pulsations of the polymer material occurring due to rotation of a standard extruder's screw, inconsistency of feeding the pellets, their fragmentation (crumbling), and uneven melting of the pellets. Therefore, this cascade provides an improved steady feeding of the mattering section of the second extruder 5 and extrusion die 11. (Alternatively, the present invention contemplates more than two extruders as well as twin-screw extruders). Cutting the extrusion pulsations helps to improve the thickness uniformity of film in the longitudinal direction (this direction is also called extrusion or “machine” direction—“MD”).

For example, for an 8 (eight) mil. thermoplastic film (200 microns), current extrusion film lines based on one single screw extruder typically provide film with a level of longitudinal non-uniformity in MD not better than +/−15-17%. For these standard extrusion film lines, the level of MD non-uniformity of 10-15% is considered to be a sign of a very good quality film. As it will be demonstrated in the Examples below, the methods for manufacturing thermoplastic films, and manufacturing systems for manufacturing the same disclosed herein, provide film made of different thermoplastics with MD non-uniformity of +/−3%-4% or better.

In accordance with an embodiment of the present invention, vacuuming of the melt, either via the vacuum unit 6 (which is attached to an evacuation port located either in the transition unit 4 between the two extruders, or in the beginning of the mattering section 7 of the second extruder 5), or through the vacuum chamber 2, or both, eliminates a large portion of various gas-phase products which may be dissolved in the polymer melt. Since the tiny bubbles of gases, air, vapors, residue of non-polymerized monomers, products of polymer degradation, and other volatiles create the light scattering in film (as noted supra), the reduction or elimination of the volatiles helps to reduce the optical density and haze of film in situations where current methods are ineffective. For crystalline and semi-crystalline thermoplastic polymers, haze reduction can be achieved to a certain level by decreasing the crystallinity and reducing the dimensions of crystalline morphological units (“domains”) in the polymer. Currently, as noted supra, this is practically achieved in the industry by sharper quenching of the molten film web on the casting drums and incorporation of nucleation agents capable of reduction of the dimensions of crystalline units and increasing their numbers. When the size of the crystalline “domains” becomes smaller than one half of the wave length of the visible light, further reduction of haze by the above-referenced means is theoretically (and practically) impossible.

This current industry technique cannot work for amorphous polymer materials, since these materials do not have a crystalline phase. (That is why amorphous polymers are inherently more transparent and have much lower optical density and haze). Methods of further reduction of haze of clear amorphous thermoplastics haven't been disclosed prior to the present invention's disclosure. As provided by an embodiment of the present invention, melt vacuuming has a positive influence on the film haze of amorphous polymer materials.

In accordance with an embodiment of the present invention, an extrusion die design is provided which comprises a die with many small sections, each of which is independently heated and thermally controlled. The die design enables a very fine set up and monitoring of the temperature across the die lips in order to control the polymer flow uniformity, and improvement of the extruded film thickness uniformity across the die and web (in the film transverse direction—“TD”). Experiments have shown, for example, that the improvement of the TD thickness uniformity of film can be achieved when the sections of the die with independently monitored temperature control are not wider than about 1/10th of the total die width. For example, for a die 10″ wide, each lip section with its own thermal controller should be not wider than about 1″. Using the described die design, thickness uniformity of extruded film in TD of about +/−4% or better was achieved, which exceeds current industry standards by several percentage points (see Examples, infra).

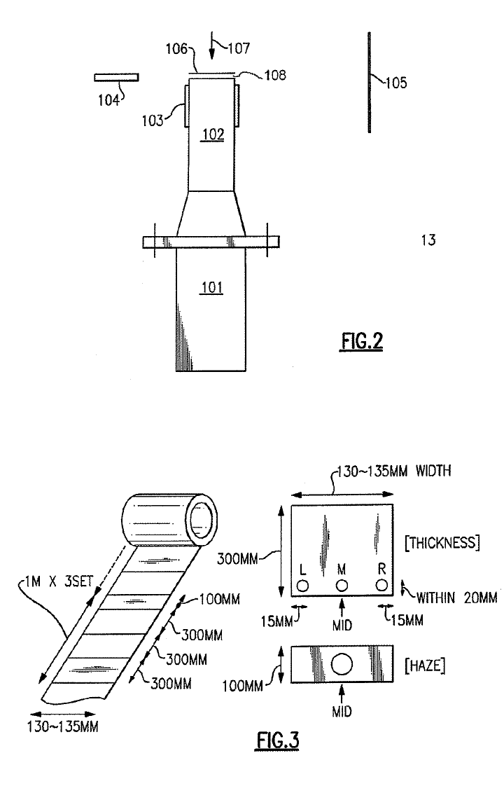

In accordance with an embodiment of the present invention, ultrasonic honinging (“USH”) of the formed film web (see FIGS. 1a-2), has been shown to significantly reduce the optical density of the polymer materials and haze values of the formed film web. USH treatment of the film web leads to improvement of film optical properties due to the following reasons: film surface smoothness improves when ultrasonic vibrations are applied to the film in regime of film levitation, preventing the film surface from touching the casting rolls and imprinting the rolls surface imperfections onto the film surface; and improvement of the structure uniformity of the material in the thin surface layer.

FIG. 2 shows a perspective view of an ultrasonic treatment (honinging) unit 13, according to an embodiment of the present invention. In accordance with an embodiment of the present invention, the ultrasonic treatment (honinging) unit 13 comprises a power magneto-strict radiator 101, acoustical (ultrasonic) wave-guide 102 (which amplifies the amplitude of vibrations of the transducer), electrical heater with the temperature controller 103, laser light source 104, screen 105, experimental polymer film sample 106, and a unit for fixing and pressing the film sample 107.

As noted supra, the ultrasonic treatment (honinging) unit 13 is used to decrease the haze of polymer film. In accordance with an embodiment of the present invention, a process by which the ultrasonic treatment (honinging) unit 13 is used to decrease the haze of polymer film will now be described with reference to current issues/problems that the ultrasonic treatment (honinging) unit 13 seeks to overcome.

A close contact between the polymer film sample 106 and the surface of the acoustical wave guide 102 is required to enable the ultrasonic vibrations to influence the polymer film 106 structure. However, such an “intimate” contact may damage (scratch) the polymer film 106 surface, resulting in negative consequences to the haze values of the polymer film 106. On the other hand, the temperature of the polymer film sample 106 has to be as close as possible to the glass transition point (Tg) of the polymer material in order to minimize the haze value. This factor can cause problems in the vicinity of the close contact between the polymer film sample 106 and the ultrasonically vibrating surface of the acoustical wave-guide 102, e.g., the polymer film sample 106 can simply “glue” to this surface.

Taking into consideration the above issues, the ultrasonic treatment (honinging) unit 13 of an embodiment of the present invention has been designed in a way to avoid the direct contact of the polymer film sample 106 and the ultrasonic wave-guide 102 surface. In particular, the ultrasonic treatment (honinging) unit 13 is used to create an “acoustical levitation”, under which the polymer film sample 106 “floats” above the wave-guide 102 surface at a minimal distance creating a “gap” 108. The heating of the polymer film sample 106 to the desired temperature takes place contemporaneously. The presence and maintenance of the required gap 108 between the polymer film sample 106 and the wave-guide 102 surface is controlled by a focused laser beam created by the laser light source 104. Additionally, the polymer film sample 106 can be loaded by a certain force in order to change the degree of it's “levitation”.

Ultrasonic levitation occurs at very large amplitudes of ultrasonic vibrations of the radiator (“horn”) only. In addition a very large radiation surface is preferable for this phenomenon to take place. Ultrasonic wave-guides (horns), which may be suitable for generating conditions capable of providing levitation of heavy objects, have been developed. It is preferable that the wave-guide for a commercial flat (casting) film extrusion process have the shape of a “Knife”. Such wave-guides have been developed, for example, by “Branson Corporation” (USA), and are very well known and widely used in the industry for the welding of polymer film and other products.

Therefore, in accordance with a preferred embodiment of the present invention, a set of Titanium Wave-guide Radiators (horns) are provided. These horns have a diameter 65 mm and a constant (equal) outer radiation surface. The range of changing the vibration amplitude is from 15 microns to 130 microns at the standard industrial vibration “net” frequency of 17.8 KHz. This leads to a maximum achievable amplitude of the vibration speed of 17 M/s. The achievable acoustical pressure required for creation of levitation is up to 1,000 N/m2. The film levitation regime can be determined and achieved for film of different thicknesses by varying the frequency or amplitude of ultrasonic vibrations. It is much simpler to change the amplitude of vibrations in the above range than the frequency of vibrations, since this would need switching to other power generators of more complicated design and much higher costs. Standard industrial ultrasonic power generators produce ultrasonic vibrations of a standard “gross” frequency of 20 KHz., which practically is equivalent to the outer “net” frequency of ˜17.8 KHz. Changing the amplitude of vibrations allows for determination of the optimal levitation conditions for film of various thicknesses.

In accordance with an embodiment of the present invention, a haze reduction of about 20-22% in average has been shown by the ultrasonic honinging of the film surface conducted after extrusion and incomplete cooling of the film, and before take-off and winding the film in rolls (see Examples, infra). In some cases a stronger haze reduction of up to 30-34%, has been shown.

In accordance with an embodiment of the present invention, the combination of the above described features and technological stages of the extrusion process and manufacturing system provides a significant improvement in film thickness uniformity on a level of about 4 (four) % in both MD and TD or better, and in many cases of about 3 (three) % or less. At the same time, the haze of film has been reduced to levels never before disclosed, for example, to 1-4% or lower for film with nominal average thickness in the range from 4 mil to 10 mil.

Advantages of the invention are illustrated by the following Examples. However, the particular materials and amounts thereof recited in these examples, as well as other conditions and details, are to be interpreted to apply broadly in the art and should not be construed to unduly restrict or limit the invention in any way.

### EXAMPLE 1

This example relates to equipment and materials used in thermoplastic film extrusion trials that have been conducted using two film extrusion lines. A standard conventional film extrusion line was compared to a film extrusion line according to an embodiment of the present invention. This comparison was accomplished by measuring the film thickness and haze values of the respective extruded polymer films. The specific equipment used in the film extrusion trials will be described, infra.

A standard laboratory film line fabricated by “Killion Extruders” (a division of Egan Corporation, Conn., USA) was used as “film extrusion line 1.” This well-known line is based on a 1″ mm single screw extruder with a 24:1 length/diameter ratio of the screw. The standard film extrusion line 1 was used for comparison to the film extrusion line (“film extrusion line 2”) and process of an embodiment of the present invention.

In accordance with an embodiment of the present invention, film extrusion line 2 of an embodiment of the present invention comprises the units and features as described supra. In particular, film extrusion line 2 included:
Extruder 1 (feeding extruder)—with screw diameter D=16 mm and length 25:1 (25 D) with 4 (four) heating sections of the barrel and 1.5 KWt drive;
Extruder 2 (mattering extruder)—with a vacuum port and screw diameter 24 mm, the length 25:1 (25 D), 1.5 KWt drive;
Vacuum station with a vacuum pump with capacity of 50 l/min, and a gas absorber with the volume of 4 (four) liters;
Flat casting extrusion die—12″ wide (˜300 mm wide) with a set of 12 (twelve) lip sections heated and controlled independently, so each section 1″ wide, and 1/12^{th} of the die total width;
The take-off rolls—340 mm (˜13.5″ wide) and 4″ (˜100 mm) in diameter, with a linear speed of 46 ft/min (14 m/min), water cooled;
Ultrasonic Honinging Unit (as described in detail, supra); and
Winder with an inner core diameter of 3″ (˜75 mm).

Polymer materials used in these thermoplastic film extrusion trials included two groups: semi-crystalline and amorphous polymers. These polymer materials (described in further detail infra) were processed using the film extrusion lines # 1 and # 2. The processing conditions were chosen to be close to optimal for the particular materials.

Altogether, six different thermoplastic polymer materials were used in these thermoplastic film extrusion trials. The group of semi-crystalline polymers included: one standard metalocene catalyzed polyethylene (m-PE—material “A”); two standard semi-crystalline acrylic copolymers by “ExxonMobil” (ethylene-methacrylate copolymer (EMAC)—material “B”; butyl-acrylate copolymer (EBAC)—material “C”); and ExxonMobil's blend of EMAC/EBAC—material “D”. Specifically, material A was metalocene catalyzed Polyethylene (m-PE) Exact 3024 by ExxonMobil with a density of 0.900 g/ccm and with a DSC peak melting point ˜98° C. Material B was EMAC by ExxonMobil EMA TC020 with a density of 0.928 g/ccm and a DSC peak melting point ˜102° C. Material C was EBAC grade 1123 from Chevron Chemical Company with a density of 0.915 g/ccm and a DSC peak melting point ˜102° C. Material D was a blend of EMAC and EBAC in ratio of 95:5. The EBAC component increases the toughness of film without sacrificing the optical properties when incorporated in small quantities (not more than 10%).

To improve the haze values of the above materials (materials A-D) in a similar manner, some nucleation agent (e.g., “Millad 3940”) was added. This nucleation agent was obtained from Milliken Company. Millad 3940 was used for these materials in a quantity of 1%. The haze values of film made of materials with and without the addition of Millad have been compared, and used for further comparison to film made using film extrusion line 2.

The above semi-crystalline polymers are known for their optical qualities, relatively low price, and excellent processability. Standard processing conditions have been used for the above materials. The extrusion temperatures are widely published by the polymer vendors, and can be found in their product literature.

The group of amorphous polymers included two completely amorphous styrene-based copolymers polymerized by “Asahi Kasei Chemicals”: a mixture of a special Styrene Copolymer F and Polymethyl-Methacrylate (PMMA), named CGV 060414-material “E”, and Random Copolymer of Styrene and another Monomer, named R 431-material “F”. These two materials (materials E and F) have been developed for optical applications by Asahi Kasei Chemicals and have very high transparency and low haze due to the amorphous nature of their morphology. The processing temperatures for these two materials have been chosen to minimize the materials thermal degradation due to their sensitivity to overheating. The following temperatures of extrusion was determined as being close to optimal: 260° C. for material E and 240° C. for material F.

All the above polymer materials have been extruded under processing conditions close to optimal for the polymer materials respectively (see the Examples, infra). The main goals of the trials described herein were fabrication of film samples, and comparison of the film samples' thickness uniformity and haze values (optical density) obtained for films made using standard extrusion technology (film extrusion line 1) with films made using a film extrusion line (film extrusion line 2) and process of an embodiment of the present invention.

Experimental trials where film samples were manufactured using both film extrusion line 1 and film extrusion line 2, and the results obtained from the evaluation of such film samples, are disclosed in the following Examples. Specifically, the following Examples relate to the extrusion of all polymer materials disclosed in this Example into 4 (four) mil (100 microns), 7 mil, 8 mil (200 microns), and/or 14 mil thick film samples, using both film extrusion lines described above.

The film samples were evaluated by measuring the film thickness and haze values. The spots for measurements (“pattern”) of the thickness and haze values have been chosen according to the schematic explanation shown in FIG. 3 (rolls of about 10 m long and flat specimens (1˜9) of about 30 cm long were used). This measurement technique is capable of providing substantially representative and reliable data for averaging the results of each series of trials. The thickness of the film samples were measured using a Federal digital micrometer (USA) or the same by “Mitsutoyo Co.” (Japan), both having the same 0.00001 mil (or 0.000025 mm) reading accuracy. These measurements were conducted every 4″ along the film web; each measurement included three measurements at the two edges (¾″ or 20 mm from the left and right edges, and in the middle of the unrolled film). The schematics of these measurements in terms of local points where the measurements took place, is shown in FIG. 3. The average values of the thickness were calculated, and variations of thickness from the average value (the thickness non-uniformity) were calculated and presented as a percentage of the average thickness.

The haze values were measured systematically, in the same spots of each film samples as they were used for thickness measurements (see FIG. 3). A Hazegard device by “BYK Gardner” (USA) and a similar Haze Meter NDH2000 by “Nippon Denshoku Co.” (Japan) were used for haze measurements of the film samples. The procedure for haze measurements followed by the ISO 13468.

### EXAMPLE 2

This Example relates to the extrusion of thermoplastic polymer materials A-D into film samples of 4 mil, 7 mil, 8 mil, and/or 14 mil thick using the film extrusion line 1, and the evaluation of thickness uniformity and haze values for such films.

The results of the thickness uniformity and haze values of these extruded film samples are summarized in Table 1, infra.

TABLE 1
Thickness uniformity and haze values for films extruded using
film extrusion line 1 of materials A-D

| | | | | Thickness | | |
|---|---|---|---|---|---|---|
| | Added Millad 1% | | Average | non-uniformity, | | |
| | No | Yes | thickness, | +/− % | | |
| Material | (−) | (+) | mil | TD | MD | Haze, % |
| A. | − | | 7 | 16 | 24 | 21 |
| A. | − | | 8 | 12 | 20 | 24 |
| A. | | | 14 | 12 | 18 | 41 |
| A. | | + | 8 | 12 | 21 | 11 |
| B. | − | | 4 | 20 | 25 | 11 |
| B. | − | | 8 | 14 | 18 | 18 |
| B. | − | | 14 | 13 | 22 | 27 |
| B. | | + | 7 | 17 | 21 | 5.5 |
| B. | | + | 8 | 14 | 18 | 6.5 |
| C. | − | | 7 | 17 | 19 | 17 |
| C. | − | | 8 | 13 | 16 | 19 |
| C. | | + | 7 | 15 | 18 | 5.5 |
| C. | | + | 8 | 14 | 18 | 7.5 |
| D. | − | | 8 | 12 | 16 | 18 |
| D. | | + | 8 | 14 | 18 | 6.5 |

The data in Table 1 shows that the average values of thickness non-uniformity achievable in a modern standard extrusion process in TD is not better than +/−12%, and in MS is even worse, not better than +/−16%. The typical haze values for film of 8 mil thick made of “clear” polymers of semi-crystalline nature is at best ˜5.5%, if a nucleation agent and sharp cooling of the web are most efficiently used.

### EXAMPLE 3

This Example relates to the extrusion of thermoplastic polymer materials A-D into film samples of two nominal/average thicknesses—4 mil and 8 mil using film extrusion line 2, and the evaluation of thickness non-uniformity and haze values for such films. Film extrusion line 2's combination of the two extruder cascade, melt vacuuming, and extrusion die with a number of independently monitored sections, was used. The ultrasonic honinging of the extruded film web, however, was not applied in this Example. The thermoplastic polymer materials A-D (the same materials used in Example 2) contained 1% of the nucleation agent Millad 3940 by Milliken.

The results of the evaluation of the thickness non-uniformity and haze values of these extruded film samples are summarized in Table 2, infra.

TABLE 2
Evaluation of film samples made in Example 3.

| | |
|---|---|
| | Thickness |
| Average | Non-uniformity, |
| Thickness, | +/− % |

| Material | Mil | TD | MD | Haze, % |
|---|---|---|---|---|
| A. | 8 | 2.0 | 2.5 | 3.6 |
| B. | 8 | 2.1 | 2.3 | 3.3 |
| C. | 8 | 2.4 | 2.4 | 3.3 |
| D | 8 | 2.8 | 2.6 | 3.6 |
| A. | 4 | 3.4 | 3.0 | 1.6 |
| B. | 4 | 3.6 | 3.0 | 1.2 |
| C. | 4 | 3.4 | 3.0 | 1.7 |
| D. | 4 | 3.9 | 3.0 | 2.1 |

The data in the Table 2 confirms fabrication of film with substantially improved thickness uniformity and haze values by film extrusion line 2, in comparison to data in Table 1 generated as a result of film fabricated by film extrusion line 1. The results in Table 2 show that the thickness non-uniformity of films in both directions, TD and MD, has been reduced to less than 4% in TD and to 3% and less in MD. The results in Table 2 also show a contemporaneous dramatic improvement in the haze values of the film to a level of 3.6% and lower.

### EXAMPLE 4

This Example relates to the extrusion of thermoplastic polymer materials E-F into film samples of two nominal/average thicknesses—4 mil and 8 mil—using the film extrusion line 1 (Experiment ## 1-2), and film extrusion line 2 (Experiment ## 3-6), without the ultrasonic honinging of the film surface. This Example also relates to the evaluation of thickness uniformity for such films.

The extruded film samples were evaluated both by “Asahi” and “AMA, Inc.” in FIG. 3. The results of the evaluation of the thickness uniformity of these extruded film samples are summarized in Table 3, infra.

TABLE 3
Test results of film made of “Asahi” amorphous co-polymers
(materials E and F) using standard film extrusion line 1
(experiment ## 1 and 2), and film extrusion line # 2 built
according to an embodiment of the present invention
(experiment ## 3, 4, 5, and 6).

| | | | Thickness | |
|---|---|---|---|---|
| | | Thickness | non-uniformity | |
| Experiment | | average, | +/− % | |
| ## | Material | mil | TD | MD |
| # 1. | E: Styrene-based | 4 | 15-19 | 9-15 |
| | Copolymer R431 | | | |
| # 2. | F: Blended Material | 4 | 9.6-19 | 7.5-18 |
| | of Styrene Copolymer + | | | |
| | PMMA CGV 060414 | | | |
| # 3. | E: R431 | 4 | 3.9-4.0 | 2.8-2.9 |
| # 4. | F: CGV | 4 | 3.8-3.9 | 2.9-3.0 |
| # 5. | E: R431 | 8 | 3.6-3.7 | 2.7-3.0 |
| # 6. | F: CGV | 8 | 3.8-3.9 | 2.9-3.0 |

The data in Table 3 show that the technology and equipment (film extrusion line 2) according to an embodiment of the present invention provide a thermoplastic film product with a significant improvement in thickness uniformity in both directions of film (TD and MD): the non-uniformity values have been improved by several times in both directions. For film made of different polymer materials, thickness non-uniformity values of equal to or better than +/−4.0% in TD and better than +/−3.0% in MD were obtained, in comparison to technology known in the art (film extrusion line 1) providing film with thickness non-uniformity values in the range of +/−7.5% to +/−19%.

### EXAMPLE 5

This Example relates to the extrusion of thermoplastic polymer materials E-F into flat film samples using the film extrusion line 1 (conducted by “Asahi Kasei Chemicals”), and film extrusion line 2 (conducted by “AMA, Inc.”), and the evaluation of the average thickness and decrease in optical density of the extruded film before and after ultrasonic honinging.

According to this Example, ultrasonic honinging was applied to the surface of extruded film web in regime of its levitation at ambient temperature, and at temperatures close to the Tg of the polymer materials E and F, i.e., 118° F. and 122° F., respectively. Ultrasonic honinging experiments for all film samples were conducted by “AMA, Inc.”

Thickness and optical density (haze) of the extruded film samples were measured before and after ultrasonic honinging. The optical density of the polymer in the film samples were measured using the Spectrum-densitometer X-RITE, model 939 using the reflecting white light rays. Aperture (the diameter of the light spot) was 16 mm, and the precision of measurements—0.001. The transparency and haze of film was estimated by the change of the optical density related to the thickness of the film sample in the light spot area. The thickness of the sample in this light spot area was measured with a precision of 0.5 microns. Tests were conducted for five samples of each material.

As it was expected, the measurements show that the ultrasonic treatment of film at ambient temperature does not change either the thickness or optical characteristics of the extruded film samples. The significant influence of the ultrasonic honinging step in accordance with an embodiment of the present invention on the film optical density and, receptively haze values, has been observed at elevated temperatures, especially at and above the glass transition points, Tg.

The results of the above described treatment of films pursuant to this Example have been summarized for various extruded film samples made of material E (experiment 1) and material F (experiment 2). Thickness and optical density (haze) results for films made by “Asahi” are shown in Table 4, and thickness and optical density (haze) results for films made of the same materials by “AMA, Inc.” (experiments # 3 and # 4 respectively are shown in Table 5, infra.

TABLE 4
Thickness and decrease of optical density of film samples made by
“Asahi” using film extrusion line 1 before and after ultrasonic
honinging (all data in the table are average results of three
measurements each).

| | Average Thickness | | |
|---|---|---|---|
| | of Film, mm | | |
| | Before | After | Decrease |
| | Ultrasonic | Ultrasonic | in Optical |
| Experiment/Material | Treatment | Treatment | Density, % |
| Experiment 1, Material “E” | 0.0935 | 0.0935 | 2.39 |
| (“Asahi's” grade R431) | 0.1050 | 0.1030 | 0.48 |
| | 0.0965 | 0.0965 | 2.46 |
| | 0.0980 | 0.1000 | 4.42 |
| | 0.0925 | 0.0960 | 5.90 |
| Average number: | | | −3.13% |
| Experiment 2, Material “F” | 0.0990 | 0.098 | 3.96 |
| (“Asahi's” grade CGV | 0.0965 | 0.0970 | 3.45 |
| 414060) | 0.0930 | 0.0930 | 2.38 |
| | 0.0980 | 0.0990 | 7.91 |
| Average number: | | | −4.42% |

TABLE 5
Thickness and decrease of optical density of film samples made by
“AMA, Inc.” using film extrusion line 2 before and after ultrasonic
honinging (all data in the table are average results of three
measurements each).

| | Average Thickness | | |
|---|---|---|---|
| | of Film, mm | | |
| | Before | After | Decrease |
| | Ultrasonic | Ultrasonic | in Optical |
| Experiment/Material | Treatment | Treatment | Density, % |
| Experiment 3, Material “E” | 0.170 | 0.172 | 1.41 |
| (“Asahi's” grade R431) | 0.200 | 0.198 | 5.14 |
| | 0.203 | 0.200 | 14.22 |
| Average number: | | | −6.92% |
| Experiment 4, Material “F” | 0.205 | 0.205 | 3.79 |
| (“Asahi's” grade CGV | 0.176 | 0.175 | 3.99 |
| 414060) | 0.182 | 0.181 | 3.61 |
| Average number: | | | −3.80% |

The results of trials in experiment ## 1-4 in this Example, summarized in Tables 4 and 5 supra, support the following conclusions: (1) Ultrasonic honinging of the extruded film samples does not substantially influence the thickness of film, confirming that the levitation regime described above is proper and efficient for film treatment; (2) Ultrasonic honinging of film positively influences the optical quality of extruded film. The optical density of both polymer materials “E” and “F” decreased on average in the range from −3% to −7%. This trend has been consistent and reliably confirmed for all film samples made by different laboratories (“Asahi” and “AMA”) using both the standard (film extrusion line 1) and the film extrusion line of an embodiment of the present invention (film extrusion line 2). In most cases, the average decrease in optical density of polymer materials by their treatment in levitation ultrasonic honinging varies in a relatively narrow range, and it is close to 4.6%; (3) The haze of extruded film is correlated to the optical density typically with an approximate ratio of 1:5, so the average reduction of film haze by ultrasonic honinging can be achieved on a level of about 20-22% respectively.

While several embodiments of the invention have been discussed, it will be appreciated by those skilled in the art that various modifications and variations of the present invention are possible. Such modification do not depart from the spirit and scope of the appended claims.

1. A method of forming a thermoplastic film comprising the steps of:
providing a thermoplastic starting material that is substantially free of plasticizers;
extruding the thermoplastic starting material to form a melt;
shaping the melt to form a thermoplastic film-web; and
at least partially cooling the thermoplastic film-web to form a thermoplastic film having an average thickness of 10 mil or less and a haze value of less than 2%.

2. The method of claim 1, wherein said thermoplastic film has an average thickness between 4 mil and 10 mil.

3. The method of claim 1, wherein the haze value is between 0.1% and 1.5%.

4. The method of claim 1, wherein said thermoplastic film comprises a thermoplastic polymer selected from the group consisting of a crystalline polymer, semi-crystalline polymer, and an amorphous polymer.

5. The method of claim 1, further comprising:
after the extruding step, subjecting the melt to low pressure; and
after the subjecting step, re-extruding the melt.

6. The method of claim 5, wherein the step of subjecting the melt to low pressure comprises subjecting the melt to a source of vacuum.

7. The method of claim 1, wherein the shaping step further comprises shaping the melt by running it through a die with a plurality of die sections, wherein said plurality of die sections are selectively independently thermally adjustable to control heat applied to the melt run through the die.

8. The method of claim 7, wherein said plurality of die sections are selectively independently adjustable to control thickness of the resultant thermoplastic film-web.

9. The method of claim 1, wherein the at least partially cooling step further comprises the step of ultrasonically honinging the at least partially cooled thermoplastic film-web.

10. The method of claim 9, wherein the step of ultrasonically honinging comprises ultrasonically treating the thermoplastic film-web by an ultrasonic wave-guide, wherein the ultrasonic wave-guide is adapted to create and maintain a gap between the surface of the ultrasonic wave-guide and the thermoplastic film-web as the thermoplastic film web passes over the ultrasonic wave-guide.

11. The method of claim 10, wherein the ultrasonic wave-guide comprises a heating member, wherein the heating member is heated to a temperature sufficient to bring the temperature of the thermoplastic film web substantially to the thermoplastic film-web's glass transition point.

12. The method of claim 10, wherein said gap is created and maintained by a laser beam.

13. A method of forming a thermoplastic film comprising the steps of:
providing a thermoplastic starting material that is substantially free of plasticizers;
extruding the thermoplastic starting material through at least a first extruder to form a melt;
shaping the melt to form a thermoplastic film-web; and
at least partially cooling the thermoplastic film-web to form a thermoplastic film having a thickness uniformity value in a transverse direction of less than 7%, and having a thickness uniformity value in a machine direction of less than 10%.

14. The method of claim 13, wherein the thickness uniformity values in the transverse direction and in the machine direction are between 2% and 4%.

15. The method of claim 13, wherein said thermoplastic film comprises a thermoplastic polymer selected from the group consisting of a crystalline polymer, semi-crystalline polymer, and an amorphous polymer.

16. The method of claim 13, further comprising;
after the extruding step, extruding the melt through a second extruder, wherein said second extruder is serially connected to said first extruder through a transition section located therebetween.

17. The method of claim 13, wherein the shaping step further comprises shaping the melt by running it through a die with a plurality of die sections, wherein said plurality of die sections are selectively independently thermally adjustable to control heat applied to the melt run through the die.

18. The method of claim 17, wherein said plurality of die sections are selectively independently adjustable to control thickness of the resultant thermoplastic film-web.

19. A method for forming a thermoplastic film comprising the steps of:
extruding a thermoplastic starting material to form a melt;
shaping the melt to form a thermoplastic film-web;
ultrasonically honinging the thermoplastic film-web when the thermoplastic film-web is in a partially cooled state.

20. The method of claim 19, wherein the step of ultrasonically honinging comprises ultrasonically treating the thermoplastic film-web by an ultrasonic wave-guide, wherein the ultrasonic wave-guide is adapted to create and maintain a gap between the surface of the ultrasonic wave-guide and the thermoplastic film-web as the thermoplastic film web passes over the ultrasonic wave-guide.

21. The method of claim 20, wherein the ultrasonic wave-guide comprises a heating member, wherein the heating member is heated to a temperature sufficient to bring the temperature of the thermoplastic film web substantially to the thermoplastic film-web's glass transition point.

22. The method of claim 20, wherein said gap is created and maintained by a laser beam.

23. A method of forming a thermoplastic film comprising the following steps in the following order:
(a) providing thermoplastic polymer pellets;
(b) feeding the thermoplastic polymer pellets into a hopper and feeding unit;
(c) extruding the thermoplastic polymer pellets through a first extruder to form a polymer melt;
(d) subjecting the polymer melt to a vacuum treatment;
(e) extruding the polymer melt through a second extruder, wherein said second extruder is serially connected to said first extruder through a transition section located therebetween;
(f) shaping the melt by running it through a flat die with a plurality of die sections, wherein the plurality of die sections are selectively thermally adjustable to control heat applied to the melt run through the die to form a thermoplastic polymer film-web, and wherein the plurality of die sections are selectively adjustable to control thickness of the resultant thermoplastic polymer film-web; and
(g) ultrasonically honinging the thermoplastic polymer film-web when the thermoplastic polymer film-web is in a partially cooled state.
